(19) United States
(12) Patent Application Publication
(10) Pub. No.: US 2025/0283834 A1
(43) Pub. Date: Sep. 11, 2025

(54) DETECTION APPARATUS FOR DETECTING DEFECT IN THREE-DIMENSIONAL (3D) STACK AND METHOD OF DETECTING DEFECT IN 3D STACK BY USING THE SAME

(71) Applicant: SAMSUNG ELECTRONICS CO., LTD., Suwon-si (KR)

(72) Inventors: Seunghoon HAN, Suwon-si (KR); Heejin Choi, Suwon-si (KR); Jaeduck Jang, Suwon-si (KR); Kyuhwan Choi, Suwon-si (KR)

(73) Assignee: SAMSUNG ELECTRONICS CO., LTD., Suwon-si (KR)

(21) Appl. No.: 19/009,583

(22) Filed: Jan. 3, 2025

(30) Foreign Application Priority Data
Mar. 11, 2024 (KR) 10-2024-0034103

(51) Int. Cl. G01N 21/95; G01N 21/47; G01N 29/04

(52) U.S. Cl. CPC G01N 21/9501; G01N 21/4738; G01N 29/04; G01N 2291/0231; G01N 2291/0289; G01N 2291/102

(57) ABSTRACT

A detection apparatus and method for detecting defects in a 3D stack are provided. The detection apparatus may include a light source configured to radiate first light to a first region of a surface of the 3D stack, and a light detector configured to receive second light emitted from a second region of the surface of the 3D stack, based on the first light being emitted to the first region, wherein the second region is located between the first region and the light source.

### CROSS-REFERENCE TO RELATED APPLICATION

This application is based on and claims priority under 35 U.S.C. § 119 to Korean Patent Application No. 10-2024-0034103, filed on Mar. 11, 2024, in the Korean Intellectual Property Office, the disclosure of which is incorporated by reference herein in its entirety.

### BACKGROUND

### 1. Field

Example embodiments of the disclosure relate to a detection apparatus for detecting defects, and more specifically, to a detection apparatus for detecting bonding interface defects in a three-dimensional (3D) stack of chips and a method of detecting defects in a 3D stack by using the same.

### 2. Description of the Related Art

Defects included in an interface of a stack structure (e.g., a chiplet) formed in a semiconductor post-processing (packaging) may be detected using ultrasonic waves. However, as the height of a stack structure increases and a bonding pitch between stacked material layers decreases, the resolution of defect detection using ultrasonic waves may be lowered and an error in the defect detection may also be increased.

### SUMMARY

One or more example embodiments may provide an apparatus for detecting bonding interface defects in a 3D stack of chips to increase detection sensitivity for defects included in the 3D stack.

One or more example embodiments may provide a method of detecting defects included in a 3D stack by using the apparatuses for detecting defects.

Additional aspects will be set forth in part in the description which follows and, in part, will be apparent from the description, or may be learned by practice of the presented embodiments of the disclosure.

According to an aspect of the present disclosure, a detection apparatus for detecting defects in a three-dimensional (3D) stack, may include: a light source configured to radiate first light to a first region of a surface of the 3D stack; and a light detector configured to receive second light emitted from a second region of the surface of the 3D stack, based on the first light being emitted to the first region, wherein the second region is located between the first region and the light source.

The light detector may be provided vertically above the second region.

The light detector may be configured to detect the second light that is scattered by a defect existing under the second region.

The light detector may be configured to detect the second light that is scatted by the detect located at the rear of the first region.

The light detector may include a plurality of pixels arranged in one dimension.

The light source may be configured to emit the first light to be incident on the first region at a a slanted angle.

The light source may be inclined at the acute angle.

The 3D stack may include a plurality of bonding pads arranged in a grid, and a portion of the plurality of bonding pads may include the defect.

The plurality of bonding pads may be arranged at a first pitch in a first direction, and a wavelength of the first light may be greater than the first pitch.

The first light may include light in an infrared band.

The first light may include polarized light.

The first light may include light in a form of a continuous wave or pulse.

According to another aspect of the present disclosure, a detection apparatus for detecting defects in a three-dimensional (3D) stack, may include: an ultrasonic emission source that radiates ultrasonic waves to a first region of a surface of the 3D stack; and an ultrasonic detector configured to receive scattered waves from a second region of the surface of the 3D stack, based on the radiated ultrasonic waves being radiated to the first region, wherein the second region may be located between the first region and the ultrasonic emission source.

The ultrasonic detector may be further configured to detect the scattered wave including ultrasonic waves that scattered by a defect existing below the second region, and at the rear of the first region.

The 3D stack may include a plurality of bonding pads arranged in a grid, and a portion of the plurality of bonding pads includes the defect.

The plurality of bonding pads may be arranged at a first pitch in a first direction, and a wavelength of the ultrasonic wave may be greater than the first pitch.

According to another aspect of the present disclosure, a method of detecting defects in a three-dimensional (3D) stack, may include: radiating first light to a first region of a surface of the 3D stack by a light source; and receiving second light emitted from a second region of the surface of the 3D stack, based on the first light being radiated to the first region, wherein the second region is located between the first region and the light source, and the light radiation and light reception are performed while the 3D stack moves in a first direction.

According to another aspect of the present disclosure, a method of detecting defects in a three-dimensional (3D) stack, may include: emitting first light having a wavelength more than twice a bonding pitch of the 3D stack, at a slanted incidence angle to the 3D stack; detecting second light emitted from the 3D stack in response to the first light; and based on the second light, determining presence of a defect exists in a bonding region of the 3D stack, and identifying a location of the defect.

The method may further include: moving the 3D stack in a propagation direction of a pulse wave of the first light or in an opposite direction of the propagation direction while the first light is emitted and the second light is detected.

The method may further include: moving a detector configured to detect the second light, in a propagation direction of a pulse wave of the first light or in an opposite direction of the propagation direction, while the first light is emitted and the second light is detected.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a cross-sectional view showing a detection apparatus for detecting bonding interface defects in a 3D stack of chips, according to an example embodiment;

FIG. 2 is a plan view of the 3D stack of FIG. 1;

FIG. 3 is a plan view showing another example of a unit 3D stack included in the 3D stack of FIG. 2;

FIG. 4 is a plan view illustrating when a region (electronic circuit region), where electronic devices of the 3D stack (e.g., semiconductor devices, optical devices, etc.) are formed, has a linear form;

FIG. 5 is a plan view showing an example of an electronic device formed in a region where the electronic devices of FIGS. 2 to 4 are formed;

FIG. 6 is a cross-sectional view showing an example of a memory cell formed in a storage node of FIG. 5; and

FIG. 7 is a perspective view showing a detection apparatus for detecting bonding interface defects in a 3D stack of chips, according to an example embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Hereinafter, an apparatus for detecting defects in a three-dimensional (3D) stack according to an example embodiment and a method of detecting defects in a 3D stack using the same are described in detail with reference to the attached drawings. The drawings are not to scale, and thicknesses of layers and regions may be exaggerated for clarification of the specification.

The embodiments of the present disclosure are capable of various modifications and may be embodied in many different forms. In a layer structure described below, when a position of an element is described using an expression “above”, “below” or “on”, the position of the element may include not only the element being “immediately in a contact manner” but also being in a non-contact manner”. In the drawings, like reference numerals refer to the like elements.

The singular forms are intended to include the plural forms as well, unless the context clearly indicates otherwise. When a part “comprises” or “includes” an element in the specification, unless otherwise defined, it is not excluding other elements but may further include other elements.

The term “above” and similar directional terms may be applied to both singular and plural. With respect to operations that constitute a method, the operations may be performed in any appropriate sequence unless the sequence of operations is clearly described or unless the context clearly indicates otherwise. The operations may not necessarily be performed in the order of sequence.

Also, in the specification, the term “units” or “ . . . modules” denote units or modules that process at least one function or operation, and may be realized by hardware, software, or a combination of hardware and software.

Connections or connection members of lines between components shown in the drawings illustrate functional connections and/or physical or circuit connections, and the connections or connection members may be represented by replaceable or additional various functional connections, physical connections, or circuit connections in an actual apparatus.

All examples or example terms are simply used to explain in detail the technical scope of the inventive concept, and thus, the scope of the inventive concept is not limited by the examples or the example terms as long as it is not defined by the claims.

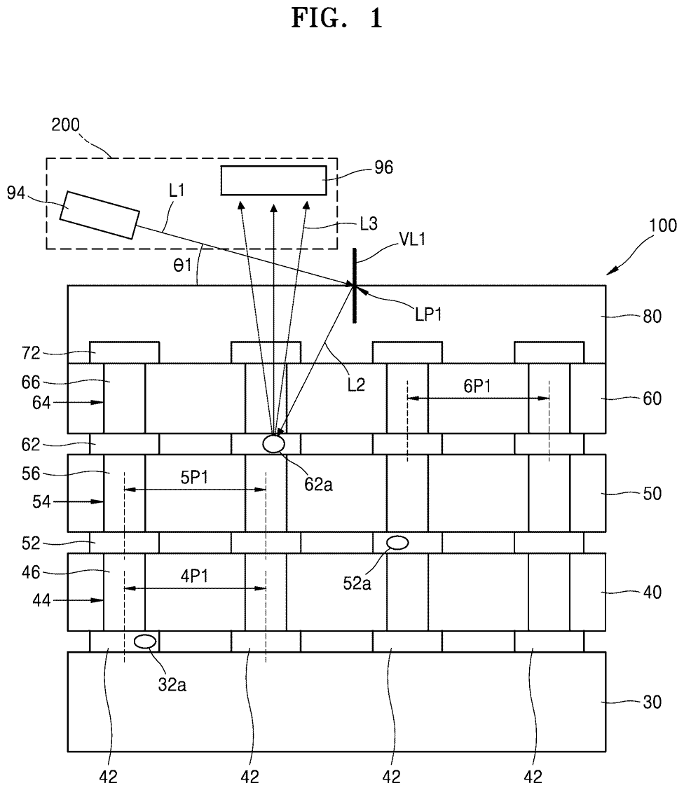

FIG. 1 shows a detection apparatus 200 for detecting bonding interface defects in a three-dimensional (3D) stack of chips according to an example embodiment.

Referring to FIG. 1, the 3D stack 100 according to an example embodiment may include a first semiconductor layer 40, a second semiconductor layer 50, and a third semiconductor layer 60 which are vertically and sequentially stacked on a substrate 30. The substrate 30 may be expressed as a base substrate or a lower substrate. A plurality of first to third bonding pads 42, 52, and 62 may be provided between the first semiconductor layer 40, the second semiconductor layer 50, and the third semiconductor layer 60. The first semiconductor layer 40, the second semiconductor layer 50, and the third semiconductor layer 60 may be bonded to each other through the plurality of first to third bonding pads 42, 52, and 62. Each of the plurality of first to third bonding pads 42, 52, and 62 may be expressed as ‘bonding pad layer’, ‘pad layer’, ‘conductive pad (layer)’, etc. The stack of the three semiconductor layers 40, 50, and 60 shown in FIG. 1 illustrates a vertical arrangement of three chips. However, the number of chips stacked in the vertical direction is not limited to three; it may range from two to thirty chips. A bonding interface (e.g., a bonding pad) may be positioned between each pair of adjacent vertically stacked chips.

In one example, the first semiconductor layer 40 may be expressed as a first wafer or a first circuit substrate. In one example, the first semiconductor layer 40 may include a plurality of electronic devices (e.g., semiconductor devices, optical devices, etc.). The plurality of electronic devices may be provided in the form of a chip but are not limited thereto. Accordingly, the first semiconductor layer 40 may be expressed as a first chip or a first semiconductor chip. For the same reason, the second semiconductor layer 50 may be expressed as a second wafer or a second circuit substrate or may be expressed as a second chip or a second semiconductor chip, and the third semiconductor layer 60 may be expressed as a third wafer or a third circuit substrate or may also be expressed as a third chip or a third semiconductor chip.

In one example, a plurality of electronic devices included in the first semiconductor layer 40, a plurality of electronic devices included in the second semiconductor layer 50, and a plurality of electronic devices included in the third semiconductor layer 60 may be the same but may be different from each other. In one example, the first semiconductor layer 40, the second semiconductor layer 50, and the third semiconductor layer 60 may include, but are not limited to, memory elements, non-memory elements, optical elements, non-optical elements, etc.

In one example, the first semiconductor layer 40, the second semiconductor layer 50, and the third semiconductor layer 60 may include electronic devices (e.g., semiconductor devices) that have the same structure and have the same function. As an example, the 3D stack 100 including the first semiconductor layer 40, the second semiconductor layer 50, and the third semiconductor layer 60 includes a high bandwidth memory (HBM), a 3D integrated circuit (IC), a 3D NAND, and a 3D stacked sensors but is not limited thereto.

The plurality of first bonding pads 42 are provided on the substrate 30 to be spaced apart from each other. In one example, the plurality of first bonding pads 42 may be spaced apart from each other at a first interval. The plurality of first bonding pads 42 may be spaced apart at substantially equal intervals. The substrate 30 and the first semiconductor layer 40 may be physically or electrically bonded (coupled) to each other through the plurality of first bonding pads 42, but the present disclosure is not limited thereto. The space between the plurality of first bonding pads 42 on the substrate 30 may be filled with an insulating layer. The insulating layer may include a gas or a solid material.

The first semiconductor layer 40 may include a plurality of first through holes 44. The number of the plurality of first through holes 44 may be the same as the number of the plurality of first bonding pads 42, but is not limited thereto. The plurality of first through holes 44 and the plurality of first bonding pads 42 may be provided to correspond one to one. In one example, each of the first through holes 44 may be located on each first bonding pad 42. That is, one first through hole 44 may be located on one first bonding pad 42, and the first bonding pad 42 may be exposed through the first through hole 44. A diameter (width) of the first through hole 44 may be less than a diameter (width) of the first bonding pad 42.

In one example, the center of the first bonding pad 42 and the center of the first through hole 44 may be aligned or substantially aligned in a vertical direction. Accordingly, the center of the first through hole 44 and the center of the first bonding pad 42 may be on the same vertical line. The first through hole 44 may be filled with a first conductive plug 46. In one example, the first through hole 44 may be completely filled with the first conductive plug 46 and may be in direct contact with the first bonding pad 42. The first conductive plug 46 may be represented as a first conductive layer.

In one example, the plurality of first bonding pads 42 may be aligned at a first pitch 4P1 on an upper surface of the substrate 30. In one example, the first pitch 4P1 may correspond to a distance between the centers of two adjacent first bonding pads 42. In one example, the first pitch 4P1 may be less than a wavelength of light L1 incident from the detection apparatus 200 to the 3D stack 100 for detecting a defect. In one example, the light L1 radiated from the detection apparatus 200 to the 3D stack 100 may include light in an infrared band (e.g., near infrared rays, short wavelength infrared rays, mid wavelength infrared rays, long wavelength infrared rays, etc.). In one example, the detection apparatus 200 may be configured to emit the light L1 with a wavelength that is more than twice the first pitch 4P1, but is not limited thereto.

In one example, ultrasound may be used instead of the light L1. Because the light L1 is light radiated to the 3D stack 100 to detect a first defect 32a, a second defect 52a, and a third defect 62a included in the 3D stack 100, the light L1 may be expressed as light for detecting defects (detection light), light for searching for defects (search light), etc. Accordingly, the detection apparatus 200 may also be expressed in various ways as a detection device or a search device.

As described above, the center of the first bonding pad 42 and the center of the first through hole 44 (or the center of the first conductive plug 46) may be considered to be substantially at the same position. Accordingly, the pitch of the first through hole 44 (or the pitch of the first conductive plug 46) may be considered to be substantially the same as the first pitch 4P1 of the first bonding pad 42.

The first bonding pad 42 may or may not include the first defect 32a, and the presence of the first defect 32a in the first bonding pad 42 may be detected by the detection apparatus 200. In one example, the first defect 32a may include, but is not limited to, voids and/or particles.

The plurality of second bonding pads 52 may be provided between the first semiconductor layer 40 and the second semiconductor layer 50. The first semiconductor layer 40 and the second semiconductor layer 50 may be bonded to each other through the second bonding pads 52. The plurality of second bonding pads 52 may be spaced apart from each other at a second interval. In one example, the second interval may be the same as the first interval but may also be different from each other. The plurality of first bonding pads 42 and the plurality of second bonding pads 52 may include a conductive material. The plurality of second bonding pads 52 may be horizontally arranged at regular intervals on the first semiconductor layer 40, and the arrangement spacing may be substantially the same. In one example, the plurality of second bonding pads 52 may be arranged at a second pitch 5P1. In one example, the second pitch 5P1 may be the same as the first pitch 4P1 or may be different from each other.

The number of second bonding pads 52 may be equal to the number of first through holes 44. The plurality of second bonding pads 52 may be arranged to correspond one-to-one with the plurality of first through holes 44. The second bonding pad 52 may be disposed on the corresponding first through hole 44 and may be provided to cover the entire first through hole 44. A diameter (width) of the second bonding pad 52 may be greater than the diameter (width) of the first through hole 44. The second bonding pad 52 may cover an entire upper surface of the first conductive plug 46 and may be in direct contact with the upper surface of the first conductive plug 46. The second bonding pad 52 may be disposed above the first bonding pad 42. The second bonding pad 52 may be disposed to face the first bonding pad 42 with the first through hole 44 and the first conductive plug 46 therebetween.

In one example, the second bonding pad 52 may be the same material layer as the first conductive plug 46 but is not limited thereto. The second bonding pad 52 may include the second defect 52a or may not include the second defect 52a. The second defect 52a may be the same as the first defect 32a or may be different from the first defect 32a.

Spaces between the plurality of second bonding pads 52 on the first semiconductor layer 40 may be filled with an insulating layer, and the insulating layer may include a gas or a solid material.

The second semiconductor layer 50 may include a plurality of second through holes 54. In one example, the number of second through holes 54 may be equal to the number of second bonding pads 52. The plurality of second through holes 54 may be arranged to correspond one-to-one with the plurality of second bonding pads 52. The second through hole 54 may be located on the second bonding pad 52. Accordingly, the second bonding pad 52 may be exposed through the second through hole 54. The center of the second through hole 54 may coincide or substantially coincide with the center of the second bonding pad 52. Accordingly, the center of the second through hole 54 and the center of the second bonding pad 52 may be located on the same vertical line. Therefore, the plurality of second through holes 54 may also be arranged at the second pitch 5P1. A diameter (width) of the second through hole 54 may be smaller than the diameter (width) of the second bonding pad 52.

The second through hole 54 may be filled with a second conductive plug 56. In one example, the second through hole 54 may be completely filled with the second conductive plug 56. Accordingly, the second conductive plug 56 may be in direct contact with the second bonding pad 52. In one example, a material of the second conductive plug 56 may be the same as the material of the first conductive plug 46, but may also be different.

A plurality of third bonding pads 62 may be provided between the second semiconductor layer 50 and the third semiconductor layer 60. The second semiconductor layer 50 and the third semiconductor layer 60 may be bonded to each other through the third bonding pads 62. The plurality of third bonding pads 62 may be spaced apart from each other at a third interval. In one example, the third interval may be the same as the second interval but may also be different. The material of the third bonding pad 62 may include the same conductive material as that of the second bonding pad 52 but may also include a different conductive material.

The plurality of third bonding pads 62 may be horizontally arranged at regular intervals on the second semiconductor layer 50, and the arrangement spacing may be substantially the same. In one example, the plurality of third bonding pads 62 may be arranged at a third pitch 6P1. In one example, the third pitch 6P1 may be the same as the second pitch 5P1, or may be different from each other.

The number of the third bonding pads 62 may be equal to the number of the second through holes 54. The plurality of third bonding pads 62 may be arranged to correspond one-to-one with the plurality of second through-holes 54. The third bonding pad 62 may be disposed on the corresponding second through hole 54 and may be provided to cover the entire corresponding second through hole 54. A diameter (width) of the third bonding pad 62 may be greater than the diameter (width) of the second through hole 54. The third bonding pad 62 may cover an entire upper surface of the second conductive plug 56 and may be in direct contact with the upper surface of the second conductive plug 56. The third bonding pad 62 may be disposed on the second bonding pad 52. The third bonding pad 62 may be disposed to face the second bonding pad 52 with the second through hole 54 and the second conductive plug 56 therebetween.

In one example, the third bonding pad 62 may be the same material layer as the second conductive plug 56 but is not limited thereto. The third bonding pad 62 may or may not include the third defect 62a, and the presence of the first defect 32a in the first bonding pad 42 may be detected by the detection apparatus 200. The third defect 62a may be the same as the first defect 32a or may be different from the first defect 32a.

Spaces between the plurality of third bonding pads 62 on the second semiconductor layer 50 may be filled with an insulating layer, and the insulating layer may include a gas or a solid material.

The third semiconductor layer 60 may include a plurality of third through holes 64. In one example, the number of the third through holes 64 may be equal to the number of the third bonding pads 62. The plurality of third through holes 64 may correspond one-to-one with the plurality of third bonding pads 62. The third through hole 64 may be located on the third bonding pad 62. Accordingly, the third bonding pad 62 may be exposed through the third through hole 64. The center of the third through hole 64 may coincide or substantially coincide with the center of the third bonding pad 62. Accordingly, the center of the third through hole 64 and the center of the third bonding pad 62 may be located on the same vertical line. Therefore, the plurality of third through holes 64 may also be arranged at the third pitch 6P1. A diameter (width) of the third through hole 64 may be less than the diameter (width) of the third bonding pad 62.

The third through hole 64 may be filled with a third conductive plug 66. In one example, the third through hole 64 may be completely filled with the third conductive plug 66. Accordingly, the third conductive plug 66 may be in direct contact with the third bonding pad 62. In one example, a material of the third conductive plug 66 may be the same as that of the first conductive plug 46 but may also be different.

A plurality of conductive pad layers 72 are provided on the third semiconductor layer 60. In one example, the plurality of conductive pad layers 72 may be contact pad layers for electrically connecting the 3D stack 100 to an external power source of the 3D stack 100, but are not limited thereto.

The plurality of conductive pad layers 72 may be provided to correspond one-to-one with the plurality of third through-holes 64. The plurality of conductive pad layers 72 are spaced apart from each other. Each of the conductive pad layers 72 may be located on the corresponding third through hole 64 and may be provided to cover the entire corresponding third through hole 64. A diameter (width) of the conductive pad layer 72 may be greater than the diameter (width) of the third through hole 64. Accordingly, the conductive pad layer 72 may cover an entire upper surface of the third conductive plug 66 and may be in direct contact with the upper surface of the third conductive plug 66.

An upper insulating layer 80 covering the plurality of conductive pad layers 72 may be provided on the third semiconductor layer 60. In one example, the upper insulating layer 80 may include, but is not limited to, oxide or nitride.

As described above, in the 3D stack 100, the first pitch 4P1, the second pitch 5P1, and the third pitch 6P1 may each be less than ½ of the wavelength of the light L1 incident on the 3D stack 100 from the detection apparatus 200. Therefore, with respect to light L1, the 3D stack 100 may be considered a meta-material. Consequently, the light L1 incident on the 3D stack 100 in the defect detection apparatus 200 may have a negative refractive index with respect to the 3D stack 100. Accordingly, the light L1 may be refracted to the left with respect to the normal line VL1, which is perpendicular to a light incident surface of the 3D stack 100. The structure and wavelength relationship (e.g., the first pitch 4P1, the second pitch 5P1, and the third pitch 6P1 being less than ½ of the wavelength of the light L1) allow the 3D stack 100 to exhibit a negative refractive index, which means that light L1 will be bent in a manner contrary to the direction expected in normal non-meta materials.

In other words, when a direction (right) heading away from a light source 94 at a point of incidence (incident point) of the light L1 incident on the 3D stack 100 from the light source 94 of the detection apparatus 200 is the front, and a direction (left) approaching the light source 94 at the incident point is the rear, the light L1 incident on the incident point of the 3D stack 100 is refracted the rear. As a result, for example, in order to search or detect the third defect 62a formed on the third bonding pad 62 of the 3D stack 100, an incident point LP1 of the defect detection light L1 incident on the 3D stack 100 from the detection apparatus 200 may be located in the front of the third defect 62a. That is, a detection target defect, that is, the third defect 62a may be located in the rear (left) of the incident point LP1 of the light L1.

The light source 94 of the detection apparatus 200 may be configured to emit light L1 to be incident on the light incident point LP1 of the 3D stack 100. For example, if an upper surface of the 3D stack 100 is flat, that is, if an upper surface of the upper insulating layer 80 is flat, the light source 94 may be provided so that the light L1 is radiated to the light incident point LP1 at a first angle 61 with respect to the upper surface of the 3D stack 100. To this end, the light source 94 itself may be disposed to be inclined at the first angle 61 with respect to the upper surface of the 3D stack 100. In one example, the light source 94 is not disposed obliquely, but an optical element that changes a direction of travel of the light L1 emitted from the light source 94 may be further provided so that the light L1 emitted from the light source 94 is incident obliquely at the first angle 81. In one example, the optical element may be a reflective member or a refractive member. The optical element may be provided within the light source 94 or provided separately from the light source 94 in the detection apparatus 200. In one example, the optical element may be provided between the light source 94 and the light incident point LP1 but is not limited thereto.

The light L1 radiated to the light incident point LP1 of the 3D stack 100 to detect the third defect 62a may be refracted backward from the light incident point LP1 and is radiated to the third defect 62a. The refracted light L2 radiated to the third defect 62a is scattered by the third defect 62a. As a result, scattered light L3 may be generated from the third defect 62a. The scattered light L3 may be expressed as scattered wave. In FIG. 1, the scattered light L3 is shown as being scattered above the third defect 62a, but this is for convenience of illustration, and the scattered light L3 may be generated in all directions of the third defect 62a. The detection apparatus 200 includes a detector 96 for detecting the scattered light L3. The detector 96 may be implemented as an image sensor or an optical detector (e.g., charge-coupled device (CCD), or complementary metal-oxide-semiconductor (CMOS) sensor) including a plurality of pixels. The detector 96 may be positioned vertically above the third defect 62a to be detected in order to detect the light L3 scattered vertically upward. That is, the detector 96 and the defect to be detected may be located substantially on the same vertical line but the disclosure is not limited thereto. As a result, both the detector 96 and the defect to be detected may be located in the rear of the light incident point LP1. An oblique angle of light L1 incident on the light incident point LP1, that is, the first angle θ1, may be set in a range that satisfies a positional relationship between the detector 96 and the defect to be detected. In one example, the first angle θ1 may be a slanted angle, and may be between 0° and 80°, between 2° and 70°, or between 2° and 50°, but is not limited thereto.

In one example, the light source 94 may include, but is not limited to, a laser diode (LD) or a light emitting diode (LED) equipped to emit light in the infrared band. In one example, the light L1 emitted from the light source 94 may include light that belongs to the infrared band and has polarization characteristics. As an example, the light L1 may have polarization characteristics parallel or perpendicular to a light incident surface. In one example, the light L1 may include light in the form of a continuous wave or light in the form of a pulse, but is not limited thereto.

In one example, the light source 94 may be replaced with an ultrasonic emission source provided to radiate ultrasonic waves to the incident point LP1 under the same incident conditions as the light L1. In this case, the detector 96 may be implemented as an ultrasonic detector for detecting ultrasonic waves scattered from the third defect 62a.

In one example, the 3D stack 100 of FIG. 1 includes a three-layer structure in which the three semiconductor layers 40, 50, and 60 are sequentially bonded, but this is shown as an example for convenience of explanation, and the 3D stack 100 may include a multi-layer structure in which three or more semiconductor layers are vertically bonded. As an example, the 3D stack 100 may include a layer structure of 1,000 layers or less, for example, between 3 layers to 30 layers, 100 layers or less, 200 layers or less, 300 layers or less, 400 layers or less, 500 layers or less, 600 layers or less, 700 layers or less, 800 layers or less, or 900 layers or less but is not limited thereto.

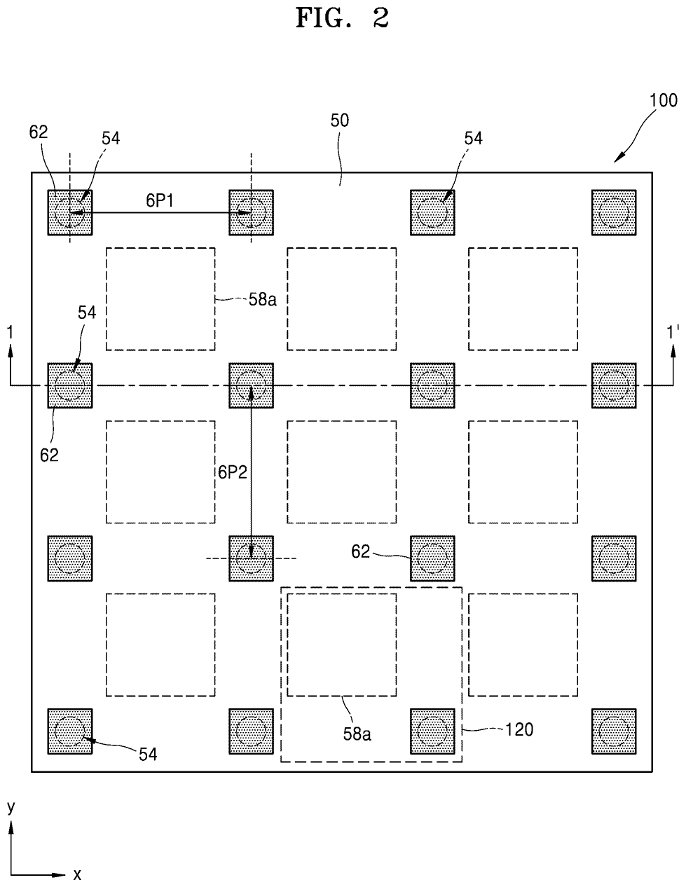

FIG. 2 shows a plan view of a result of removing the third semiconductor layer 60 and the upper insulating layer 80 in FIG. 1. A cross section of FIG. 2 cut in a 1-1′ direction may be FIG. 1.

Referring to FIG. 2, the plurality of third bonding pads 62 are arranged in a grid shape. That is, the plurality of third bonding pads 62 may be arranged to form rows and columns. The third bonding pads 62 are arranged at the third pitch 6P1 in a first direction (e.g., x-axis direction) and at a fourth pitch 6P2 in a second direction (e.g., y-axis direction) perpendicular to the first direction. In one example, the third pitch 6P1 and the fourth pitch 6P2 may be the same as or different from each other.

Reference number 58a indicates a region where electronic devices of the second semiconductor layer 50 are positioned. The region 58a of the electronic device (hereinafter, an electronic device region 58a) may be expressed as an electronic circuit region, a semiconductor device region, a semiconductor circuit region, a circuit region, or a circuit section. The electronic device region 58a may include a plurality of electronic devices (e.g., semiconductor devices, optical devices, memories, etc.).

The second semiconductor layer 50 may include a plurality of electronic device regions 58a spaced apart from each other. In one example, four third bonding pads 62 may correspond to one electronic device region 58a. In one example, a portion of the four third bonding pads 62 may be shared with the adjacent electronic device region 58a. The plurality of electronic device regions 58a may form rows and columns. In one example, rows of electronic device regions 58a may be located between rows of third bonding pads 62, and columns of electronic device regions 58a may be located between columns of third bonding pads 62. A plurality of third bonding pads 62 may be formed on the second semiconductor layer 50 between the plurality of electronic device regions 58a. That is, the third bonding pad 62 may be provided in a region where electronic devices are not formed between the electronic device regions 58a on the second semiconductor layer 50 but is not limited thereto.

One electronic device region 58a and at least one of the third bonding pads 62 disposed around the electronic device region 58a may form a unit 3D stack 120. As an example, the unit 3D stack 120 may include one electronic device region 58a and one third bonding pad 62 disposed around the electronic device region 58a. In one example, a result of repeating the unit 3D stack 120 in the first and second directions may be the 3D stack 100.

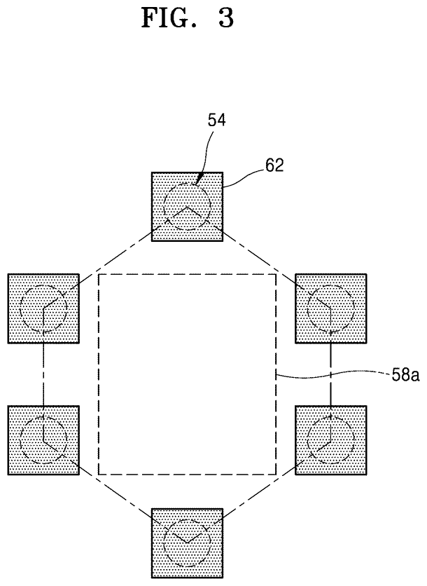

The arrangement of the third bonding pads 62 around the electronic device region 58a may be varied in various ways, and FIG. 3 shows an example thereof.

Referring to FIG. 3, six third bonding pads 62 may be disposed around one electronic device region 58a. The six third bonding pads 62 may be arranged along a boundary of a hexagonal shape around the electronic device region 58a. In the case of FIG. 3, a planar shape of the electronic device region 58a may also be set to be hexagonal.

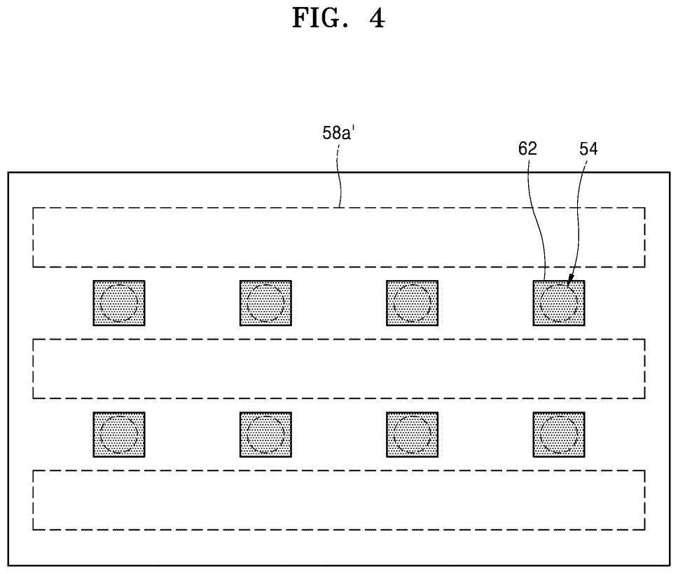

In one example, the plurality of electronic device regions 58a′ may be arranged along a straight line, as shown in FIG. 4. In this case, the plurality of third bonding pads 62 may be disposed between the electronic device regions 58a′ having the line form. For example, the plurality of electronic device regions 58a′ are arranged in multiple rows, and the plurality of third bonding pads 62 are arranged in additional rows positioned between every two adjacent rows of the electronic device regions 58a′.

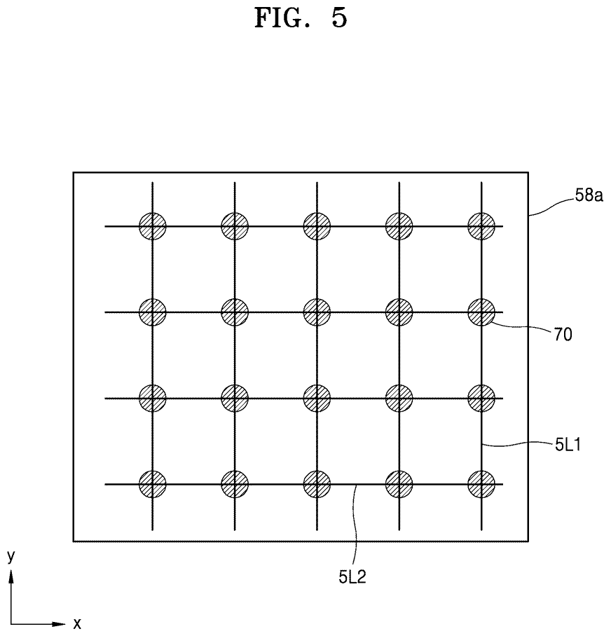

FIG. 5 illustrates a case when the electronic device region 58a includes a memory.

Referring to FIG. 5, the electronic device region 58a includes first wirings 5L1 aligned at given intervals in the first direction (e.g., x-axis direction) and second wirings 5L2 aligned at a given interval in the second direction (e.g., y-axis direction) perpendicular to the first direction. The first wiring 5L1 and the second wiring 5L2 may be arranged to cross each other. In one example, one of the first wiring 5L1 and the second wiring 5L2 may be word lines and the other may be bit lines. A memory node 70 is provided at an intersection of the first wiring 5L1 and the second wiring 5L2. The memory node 70 may include memory cells.

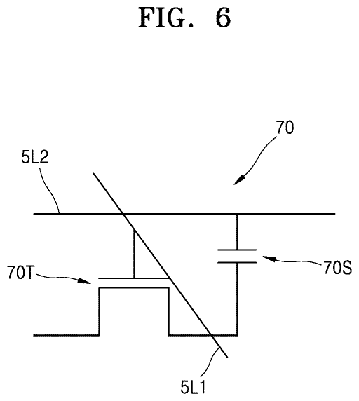

In one example, as shown in FIG. 6, the memory node 70 may include one field effect transistor (FET) 70T and one data storage element 70S connected to the one field effect transistor 70T.

In one example, the data storage element 70S may include volatile or non-volatile data storage elements. For example, the data storage element 70S may use a dielectric layer or a ferroelectric layer, or may include a material layer having magnetoresistive properties or phase change properties.

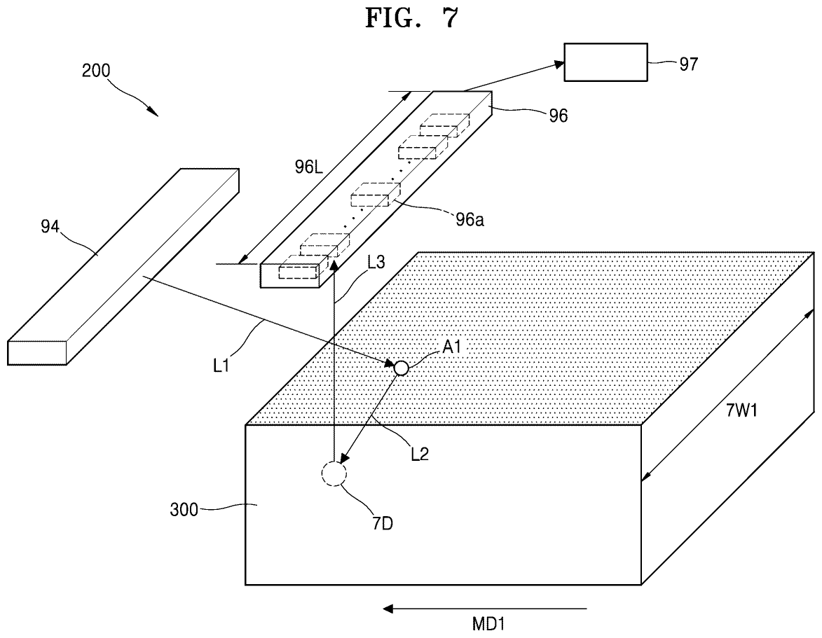

FIG. 7 is a perspective view of the detection apparatus 200 of FIG. 1.

Referring to FIG. 7, a defect detection process includes radiating light L1 from the light source 94 to a first region A1 of an upper surface of a 3D stack 300 having a negative refractive index. The light L1 may be a probing signal modulated using a pulsed approach, which involves generating short bursts of the probing signal at regular or varying intervals. The pulses may have exponentially decaying profiles over time advancement, which allows enhancing imaging resolutions of the embedded defects. The light L1 may be modulated to encompass a specific frequency bandwidth, allowing for a broader range of signal analysis. The first region A1 may be located in front of a defect 7D to be detected. The light L1 radiated to the first region A1 is refracted from the first region A1 into the 3D stack 300. Because the 3D stack 300 is an effective meta-material corresponding to the 3D stack 100 of FIG. 1, light L2 refracted in the first region A1 is refracted backward to incident on the defect 7D. The light L2 incident on the defect 7D is scattered by the defect 7D, and scattered light L3 may be incident on the detector 96 located vertically above the defect 7D. In one example, the scattered light L3 may be a portion of the light scattered by the defect 7D. Defects at a depth shallower than the defect 7D or defects deeper than the defect 7D may be detected by adjusting an angle of incidence of the light L1 incident on the first region A1 with respect to the upper surface of the 3D stack 300. The detection apparatus 200 may include a processor 97 configured to analyze a signal output from the plurality of pixels 96a included in the detector 96. The plurality of pixels 96a may be arranged to capture the scattered light L3 as the light L2 interacts with the defect 7D. The processor 97 may include a central processing unit (CPU), an arithmetic logic unit (ALU), or another hardware structure configured to fetch instructions from memory and execute them. The processor 97 may analyze the signal output from the detector 96 in a time domain and/or in a frequency domain. In the time domain, the processor 97 may measure the time of flight (TOF) of the probing signal as it travels to and from the 3D stack 100, with TOF measurements used to determine the presence and location of the defect 7D. In the frequency domain, the processor 97 may analyze the frequency components of the signal received from the detector 96. This time domain analysis and/or frequency domain analysis may enable the processor 97 to identify the presence and location of the defect 7D.

Inside the 3D stack 300, scattered light may be generated by a semiconductor device (e.g., transistor) on a path of the refracted light L2 together with scattered light by the defect 7D, but the intensity of the scattered light generated by the semiconductor device may be much lower compared to the intensity of the scattered light generated by the defect 7D.

Accordingly, when the detection apparatus 200 described above is used, the reception sensitivity for scattered light generated from the defect 7D may be relatively high, and thus, the detection accuracy of the defect 7D (i.e., the accuracy of searching for the defected portion) may be increased. That is, when the illustrated detection apparatus 200 is used, the presence of the defect 7D may be detected more accurately.

By accurately detecting the location (e.g., depth) of the defect 7D, a cause of the defect 7D may be identified and removed by tracking the processes involved in forming the 3D stack 300 where the defect 7D is present. This may reduce the rate of defect occurrence during the manufacturing process of the 3D stack 300.

In one example, the detector 96 may include a plurality of pixels 96a arranged in one dimension (or in the first direction). In one example, the plurality of pixels 96a may be aligned in a length direction 96L of the detector 96. The detector 96 may have a length 96L in a direction perpendicular to a moving direction MD1 of the 3D stack 300. In one example, the length 96L of the detector 96 may be equal to a width 7W1 of the 3D stack 300 in a direction perpendicular to the direction of movement MD1 of the 3D stack 300, but is not limited thereto. The number of the plurality of pixels 96a may be equal to the number of bonding pads disposed in the one-dimensional region of the 3D stack 300 corresponding to the length 96L of the detector 96 but is not limited thereto. Therefore, as the 3D stack 300 moves from right to left, a line scan (light radiation and scattered light reception) for defect detection may be sequentially performed from the left end to the right end of the 3D stack 300, and as a result, defects may be detected throughout the 3D stack 300.

In one example, the light source 94 may be oriented in the same direction as the detector 96 and have the same length but is not limited thereto. The light source 94 may radiate line-shaped light toward the 3D stack 300. In one example, a width of the line-shaped light may be the same as or different from the width 7W1 of the 3D stack 300.

FIG. 7 illustrates that the detection apparatus 200 is fixed and the 3D stack 300 is moving, but a different configuration is also possible. That is, the 3D stack 300 may be fixed and the detection apparatus 200 may be moved in a direction opposite to a movement direction of the 3D stack 300.

The disclosed defect detection apparatus of the 3D stack uses light (e.g., infrared rays) having a longer wavelength than the pitch of the plurality of bonding pads included in the 3D stack as detection (search) light. Accordingly, the 3D stack may be considered a meta material with a negative refractive index. Therefore, when detection light is radiated in front of a defect included in the 3D stack, the detection light is refracted toward the defect and scattered light is generated from the defect. The scattered light may be detected by using a detector located vertically above the defect. Accordingly, the detection sensitivity of light scattered from a defect may be increased, and as a result, the resolution of the defect may be increased, thereby reducing detection error.

While one or more embodiments have been described, it will be understood by those of ordinary skill in the art that various changes in form and details may be made therein without departing from the spirit and scope as defined by the following claims. Therefore, the scope of the disclosure is defined not by the detailed description of the invention but by the appended claims.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A detection apparatus for detecting defects in a three-dimensional (3D) stack, the detection apparatus comprising:
a light source configured to radiate first light to a first region of a surface of the 3D stack; and
a light detector configured to receive second light emitted from a second region of the surface of the 3D stack, based on the first light being emitted to the first region,
wherein the second region is located between the first region and the light source.

2. The detection apparatus of claim 1, wherein the light detector is provided vertically above the second region.

3. The detection apparatus of claim 1, wherein the light detector is configured to detect the second light that is scattered by a defect existing under the second region.

4. The detection apparatus of claim 3, wherein the light detector is configured to detect the second light that is scatted by the detect located at the rear of the first region.

5. The detection apparatus of claim 3, wherein the light detector comprises a plurality of pixels arranged in one dimension.

6. The detection apparatus of claim 1, wherein the light source is configured to emit the first light to be incident on the first region at a slanted angle.

7. The detection apparatus of claim 6, wherein the light source is inclined at the slanted angle.

8. The detection apparatus of claim 4, wherein
the 3D stack comprises a plurality of bonding pads arranged in a grid, and a portion of the plurality of bonding pads comprises the defect.

9. The detection apparatus of claim 8, wherein
the plurality of bonding pads are arranged at a first pitch in a first direction, and
a wavelength of the first light is greater than the first pitch.

10. The detection apparatus of claim 1, wherein the first light comprises light in an infrared band.

11. The detection apparatus of claim 10, wherein the first light comprises polarized light.

12. The detection apparatus of claim 10, wherein the first light comprises light in a form of a continuous wave or pulse.

13. A detection apparatus for detecting defects in a three-dimensional (3D) stack, the detection apparatus comprising:
an ultrasonic emission source that radiates ultrasonic waves to a first region of a surface of the 3D stack; and
an ultrasonic detector configured to receive scattered waves from a second region of the surface of the 3D stack, based on the radiated ultrasonic waves being radiated to the first region,
wherein the second region is located between the first region and the ultrasonic emission source.

14. The detection apparatus of claim 13, wherein
the ultrasonic detector is further configured to detect the scattered wave comprising ultrasonic waves that scattered by a defect existing below the second region, and at the rear of the first region.

15. The detection apparatus of claim 14, wherein
the 3D stack comprises a plurality of bonding pads arranged in a grid, and a portion of the plurality of bonding pads includes the defect.

16. The detection apparatus of claim 15, wherein
the plurality of bonding pads are arranged at a first pitch in a first direction, and
a wavelength of the ultrasonic wave is greater than the first pitch.

17. A method of detecting defects in a three-dimensional (3D) stack, the method comprising:
radiating first light to a first region of a surface of the 3D stack by a light source; and
receiving second light emitted from a second region of the surface of the 3D stack, based on the first light being radiated to the first region,
wherein the second region is located between the first region and the light source, and
the light radiation and light reception are performed while the 3D stack moves in a first direction.

18. A method of detecting defects in a three-dimensional (3D) stack of chips, the method comprising:
emitting first light having a wavelength more than twice a bonding pitch of the 3D stack;
detecting second light emitted from the 3D stack in response to the first light; and
based on the second light, determining presence of a defect exists in a bonding region of the 3D stack, and identifying a location of the defect.

19. The method of claim 18, further comprising:
moving the 3D stack in a propagation direction of a pulse wave of the first light or in an opposite direction of the propagation direction while the first light is emitted and the second light is detected.

20. The method of claim 18, further comprising:
moving a detector configured to detect the second light, in a propagation direction of a pulse wave of the first light or in an opposite direction of the propagation direction, while the first light is emitted and the second light is detected.
